(19) United States
(12) Patent Application Publication
(10) Pub. No.: US 2008/0277026 A1
(43) Pub. Date: Nov. 13, 2008

(54) JOINT FOR CONNECTING WOOD MEMBERS

(76) Inventor: Gary Sill, Forest, VA (US)

Correspondence Address: Brian J. Teague;Thomas & Raring, P.C., 536 Granite Avenue, Richmond, VA, 23226, US

(21) Appl. No.: 12/103,073

(22) Filed: Apr. 15, 2008

Related U.S. Application Data
(60) Provisional application No. 60/916,347, filed on May 7, 2007.

(51) Int. Cl. B27D 1/10; F16B 11/00

(52) U.S. Cl. 144/344; 403/268

(57) ABSTRACT

A joint for joining one board to another board comprises a plurality of alternating top and bottom fingers. The top fingers each have a top surface and a sloped surface. The top surfaces of the top fingers are level and contiguous with the top surface of the board, and the sloped surfaces angle from the outer ends of the top fingers inward and downward to the bottom surface of the board. The bottom fingers each have a bottom surface and a sloped surface. The bottom surfaces of the bottom fingers are level and contiguous with the bottom surface of the board, and the sloped surfaces angle from the outer ends of the bottom fingers inward and upward to the top surface of the board. When two boards having such joints are joined, the top fingers of each board interlace and the bottom fingers of each board interlace.

### CROSS-REFERENCE TO RELATED APPLICATIONS

This application claims priority to U.S. Provisional Application No. 60/916,347, filed May 7, 2007, the contents of which are incorporated herein by reference in its entirety.

### FIELD OF THE INVENTION

This invention relates to a joint for connecting wood members.

### BACKGROUND OF THE INVENTION

It is known to join two lengths of wood to one another by cutting the ends of the timber with special cutters which form a series of deep V-shaped grooves thus forming fingers therebetween. This type of joint is termed a finger joint. The grooves are so shaped that they interfit with the fingers of the other piece of timber. Glue is applied to the fingers and the two pieces of timber are then joined. The finger jointing may be used when weaknesses in the timber appear, for example, at the location of knots in the timber. The weakness may be cut out, and the remaining portions of timber finger jointed back together. The finger jointed timber is then significantly stronger than the timber with the knots therein. Thus, use can be made of timber which had faults therein and the resulting end product is substantially as strong as timber without any faults. Similarly, finger jointing may be used when a woodworking process results in numerous wood scraps which are too short to be useful. The scraps may be finger jointed to form wood members of sufficient length to be useful. Finger jointing may also be used to create boards longer than might otherwise be available.

### BRIEF SUMMARY

In one embodiment of the invention, a joint is used to join a board having opposing first and second surfaces to another board having a corresponding joint. The joint comprises a first finger and a second finger. The first finger has (i) a first surface that is even and contiguous with the first surface of the board, (ii) a second surface that slopes inward from a distal end of the first finger toward the second surface of the board, and (iii) opposing side walls perpendicular to the first surface of the board. The second finger has (i) a first surface that is even and contiguous with the second surface of the board, (ii) a second surface that slopes inward from a distal end of the second finger toward the first surface of the board, and (iii) opposing side walls perpendicular to the second surface of the board. When the board is joined to the other board, the second surface of the first finger of the board contacts a corresponding second surface of a second finger of the other board, and the second surface of the second finger of the board contacts a corresponding second surface of a first finger of the other board.

In one embodiment, the angle of the slope of the second surface of the first finger relative to the first surface of the board is substantially equal to an angle of the slope of the second surface of the second finger relative to the second surface of the board.

In one embodiment, the angle of the slope of the second surface of the first finger relative to the first surface of the board is substantially equal to an angle of a slope of the second surface of the corresponding second finger of the other board relative to a second surface of the other board, and the angle of the slope of the second surface of the second finger relative to the second surface of the board is substantially equal to an angle of a slope of the second surface of the corresponding first finger of the other board relative to a first surface of the other board.

In one embodiment, the joint further comprises a plurality of alternating first and second fingers spanning an entire width of the board. When the board is joined to the other board, at least one side wall of each first finger of the board contacts a corresponding side wall of a first finger of the other board, and at least one side wall of each second finger of the board contacts a corresponding side wall of a second finger of the other board. Each first finger has a length that is substantially equal to a length of each other first finger, and each second finger has a length that is substantially equal to a length of each other second finger. The length of each first finger and the length of each second finger are substantially equal.

In addition to the joint for joining a board to another board as described above, other aspects of the present invention are directed to corresponding methods for joining a first board and a second board.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of two wood members joined with the joint of one embodiment of the present invention;

FIG. 2 is a perspective view of the two wood members of FIG. 1 in a separated position;

FIG. 3 is a top view of the two wood members of FIG. 2;

FIG. 4 is an end view of a wood member of FIG. 2;

FIG. 5 is a side view of the two wood members of FIG. 2;

FIGS. 6A, 6B are a perspective and side view, respectively, of two wood members joined with the joint of an alternative embodiment of the present invention;

FIGS. 7A, 7B are a perspective and side view, respectively, of the two wood members of FIGS. 6A, 6B in a separated position;

FIGS. 8A, 8B are a perspective and side view, respectively, of two wood members joined with the joint of an alternative embodiment of the present invention; and

FIGS. 9A, 9B are a perspective and side view, respectively, of the two wood members of FIGS. 8A, 8B in a separated position.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

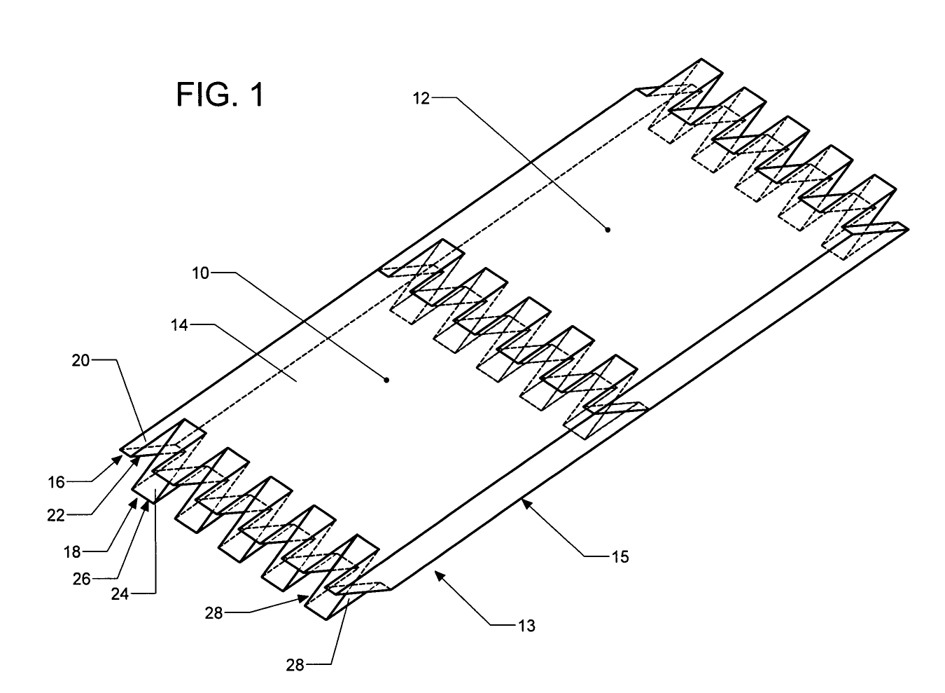

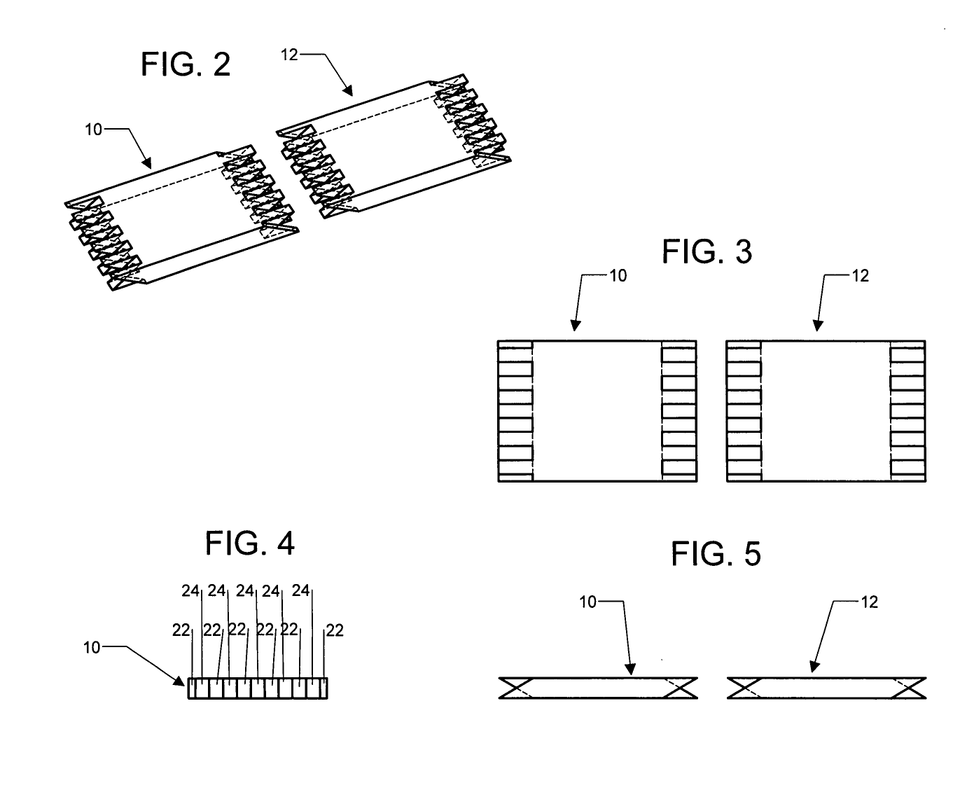

Referring now to FIG. 1, a perspective view of two wood members 10, 12 joined with the finger joint of the present invention is illustrated. As can be seen in FIG. 1, both wood members may have finger joints at both ends, thereby enabling additional wood members (not illustrated) to be joined to the two illustrated members. However, the finger joint of the present application may be used at only one end of a wood member, with the other end having a butt or square end. The elements of the finger joint 13 of the wood member 10 will be described herein relative to a top surface 14 and bottom surface 15 (not visible) of the wood member 10, however the terms top, bottom, top surface, bottom surface, top finger, and bottom finger are used for illustrative purposes only and are not intended to be limiting.

The finger joint 13 comprises a plurality of alternating top fingers 16 and bottom fingers 18. The top fingers 16 each have a top surface 20 and a sloped surface 22. The top surface 20 of the top fingers is level and contiguous with the top surface 14 of the wood member. The sloped surface 22 of the top fingers angles from the outer ends of the top fingers inward and downward to the bottom surface 15 of the wood member.

The bottom fingers 18 each have a bottom surface 26 and a sloped surface 24. The bottom surface 26 of the bottom fingers is level and contiguous with the bottom surface 15 of the wood member. The sloped surface 24 of the bottom fingers angles from the outer ends of the bottom fingers inward and upward to the top surface 14 of the wood member.

The top and bottom fingers each have two opposing side walls 28 perpendicular to the top and bottom surfaces of the board.

When two wood members having such finger joints are joined, the top fingers of each wood member interlace and the bottom fingers of the each wood member also interlace. Assuming the two wood members have substantially the same thicknesses, the interlacing results in a substantially smooth joint between the two members. This interlacing further causes the side wall(s) 28 of each finger to contact a corresponding side wall of an adjacent finger on the other board. (Except for the two outermost fingers, both side walls of each finger will contact a corresponding side wall of a finger on the other board. For the two outermost fingers, only one side wall (i.e., the “inside” side wall) will contact a corresponding side wall of a finger on the other board.) The sloped surfaces of the top fingers of each wood member contact the sloped surfaces of corresponding bottom fingers of the other wood member. An adhesive would be applied to the sloped surfaces and side walls of the fingers before the wood members are joined (for the two outermost fingers, the adhesive will be applied to only one side wall (i.e., the “inside” side wall)), providing a strong bond between the two members once the adhesive has cured. The contact between the side walls provides lateral strength to the joint, while the contact between the sloped surfaces provides vertical strength to the joint.

The angle of the sloped surfaces of the top fingers relative to the top surface and the angle of the sloped surfaces of the bottom fingers relative to the bottom surface may vary from about 5 degrees to about 88 degrees. The angles for both the top and bottom fingers should be substantially the same to ensure proper contact between the sloped surfaces. A relatively greater angle enables shorter fingers and more efficient use of the wood, but with a weaker joint due to less surface area contact between fingers. A relatively smaller angle results in longer fingers and less efficient use of the wood, but provides a stronger joint due to more surface area contact between fingers. Thus, the angle selection typically entails a trade-off between joint strength and efficient use of wood. The angle that is selected for a particular application may vary based on many factors, such as the thickness of the members to be joined. For example, relatively thick boards or beams may use a relatively steep angle (e.g., greater than 45 degrees), while relatively thin boards or beams may use a relatively shallow angle (e.g., less than 45 degrees).

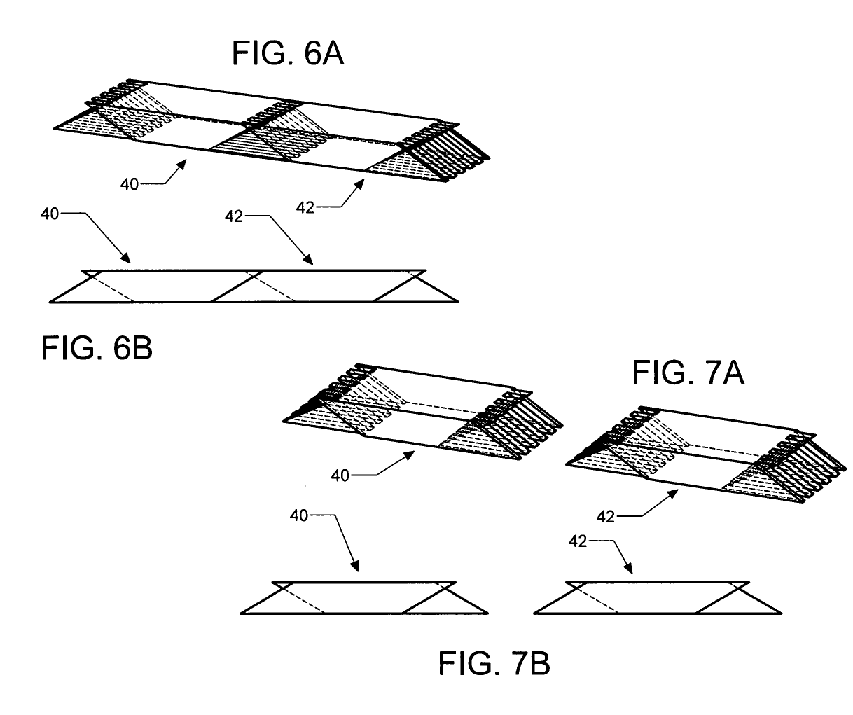

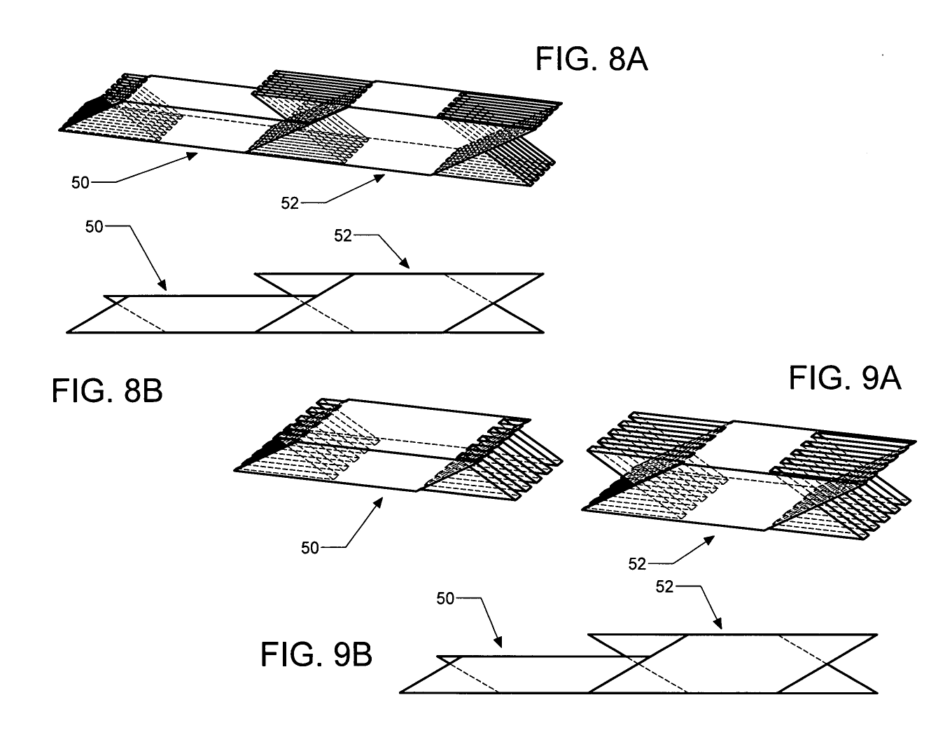

The top fingers and bottom fingers partially overlap, as viewed from the side. This can be readily seen in FIG. 5, in which the sloped surfaces of the top and bottom fingers form an “X” shape when viewed from the side. Although the “X” shape shown in the embodiment of FIG. 5 is symmetrical (both horizontally and vertically), in other embodiments of the invention the finger joint may be structured such that the “X” shape is not symmetrical (either horizontally, vertically, or both). For example, in some applications it may be advantageous to have the joint structured such that the center of the “X” is closer to the top of the joined boards 40, 42 as illustrated in FIGS. 6A, 6B, 7A and 7B. Such a configuration could create a joint that is able to withstand greater stresses from one side than the other side, which may be desirable in applications such as pallet deck boards. In another example, an asymmetrical “X” may result in an embodiment of the invention in which the fingers of the joints are structured such that one board may have an “offset” orientation relative to the other board in the joint (i.e., such that the horizontal center of one board is offset from the horizontal center of the other board). Such a structure can enable the joining of two boards 50, 52 of different thicknesses while maintaining a smooth-surfaced joint on one side of the boards as illustrated in FIGS. 8A, 8B, 9A, and 9B. Similarly, an asymmetrical “X” may result in an embodiment of the invention in which the fingers of the joints are structured such that two boards of different thicknesses may be joined with one board having a “centered” orientation relative to the other board in the joint (i.e., such that the horizontal center of one board is even with the horizontal center of the other board). If two boards of different thicknesses are joined in such a “centered” orientation, neither side would have a smooth-surfaced joint but the difference in thickness of the two boards would be divided between the two surfaces.

While the figures illustrate a finger joint having five top fingers and five bottom fingers on each wood member, it should be appreciated that the number of fingers may vary. The number of fingers used for any particular finger joint may depend on many variables, such as the dimensions (width, length, depth) of the wood members. In a preferred embodiment, however, the finger joint will have at least three fingers (i.e., two top fingers and one bottom finger or one top finger and two bottom fingers) on each wood member. The use of at least three fingers on each wood member provides a stronger joint that is better able to withstand a torsional (i.e., twisting) force.

The finger joint of embodiments of the present invention encompasses numerous desirable features and advantages. Research indicates that stronger finger joints typically result when the individual fingers have sharp, rather than rounded, distal edges (i.e., where the top or bottom surface meets the sloped surface). The finger joint of the present invention provides sharp edges where the tip of each finger meets the surface of the adjoining board. Further, the finger joint of the present invention provides a relatively strong joint even without any adhesive.

While embodiments of the invention are described for use with wood members, it should be appreciated that the finger joints described herein may be used to join members made of any material which is capable of being formed (e.g., by milling, casting, or molding) into the desired finger shapes. For example, the finger joints described herein may be used to join members made of plastics or other polymers, composite materials (e.g., wood-plastic composite), or metals.

That which is claimed:

1. A board having opposing first and second surfaces and a joint for joining the board to another board having a corresponding joint, the joint comprising:
a first finger having (i) a first surface that is even and contiguous with the first surface of the board, (ii) a second surface that slopes inward from a distal end of the first finger toward the second surface of the board, and (iii) opposing side walls perpendicular to the first surface of the board; and
a second finger having (i) a first surface that is even and contiguous with the second surface of the board, (ii) a second surface that slopes inward from a distal end of the second finger toward the first surface of the board, and (iii) opposing side walls perpendicular to the second surface of the board;
wherein, when the board is joined to the other board, the second surface of the first finger of the board contacts a corresponding second surface of a second finger of the other board, and the second surface of the second finger of the board contacts a corresponding second surface of a first finger of the other board.

2. The board of claim 1, wherein an angle of the slope of the second surface of the first finger relative to the first surface of the board is substantially equal to an angle of the slope of the second surface of the second finger relative to the second surface of the board.

3. The board of claim 2, wherein the angle of the slope of the second surface of the first finger relative to the first surface of the board is substantially equal to an angle of a slope of the second surface of the corresponding second finger of the other board relative to a second surface of the other board, and wherein the angle of the slope of the second surface of the second finger relative to the second surface of the board is substantially equal to an angle of a slope of the second surface of the corresponding first finger of the other board relative to a first surface of the other board.

4. The board of claim 1, wherein the joint further comprises a plurality of alternating first and second fingers.

5. The board of claim 4, wherein, when the board is joined to the other board, at least one side wall of each first finger of the board contacts a corresponding side wall of a first finger of the other board, and at least one side wall of each second finger of the board contacts a corresponding side wall of a second finger of the other board.

6. The board of claim 4, wherein each first finger has a length that is substantially equal to a length of each other first finger, and wherein each second finger has a length that is substantially equal to a length of each other second finger.

7. The board of claim 6, wherein the length of each first finger and the length of each second finger are substantially equal.

8. The board of claim 4, wherein the plurality of first and second fingers span an entire width of the board.

9. A method of joining a first board to a second board, the boards having opposing first and second surfaces, the method comprising:
(a) forming a joint in the first board, the joint comprising:
a first finger having (i) a first surface that is even and contiguous with the first surface of the first board, (ii) a second surface that slopes inward from a distal end of the first finger toward the second surface of the first board, and (iii) opposing side walls perpendicular to the first surface of the first board; and
a second finger having (i) a first surface that is even and contiguous with the second surface of the first board, (ii) a second surface that slopes inward from a distal end of the second finger toward the first surface of the first board, and (iii) opposing side walls perpendicular to the second surface of the first board;
wherein an angle of the slope of the second surface of the first finger relative to the first surface of the board is substantially equal to an angle of the slope of the second surface of the second finger relative to the second surface of the board;
(b) forming a joint in the second board, the joint comprising:
a first finger having (i) a first surface that is even and contiguous with the first surface of the second board, (ii) a second surface that slopes inward from a distal end of the first finger toward the second surface of the second board, and (iii) opposing side walls perpendicular to the first surface of the second board; and
a second finger having (i) a first surface that is even and contiguous with the second surface of the second board, (ii) a second surface that slopes inward from a distal end of the second finger toward the first surface of the second board, and (iii) opposing side walls perpendicular to the second surface of the second board; and
(c) joining the first board and the second board such that the second surface of the first finger of the first board contacts a corresponding second surface of a second finger of the second board, and the second surface of the second finger of the first board contacts a corresponding second surface of a first finger of the second board.

10. The method of claim 9, wherein the joint of the first board is formed such that an angle of the slope of the second surface of the first finger of the first board relative to the first surface of the first board is substantially equal to an angle of the slope of the second surface of the second finger of the first board relative to the second surface of the first board;
wherein the joint of the second board is formed such that an angle of the slope of the second surface of the first finger of the second board relative to the first surface of the second board is substantially equal to an angle of the slope of the second surface of the second finger of the second board relative to the second surface of the second board;

11. The method of claim 10, wherein the joints of the first and second boards are formed such that the angle of the slope of the second surface of the first finger relative to the first surface of the board is substantially equal to an angle of a slope of the second surface of the corresponding second finger of the other board relative to a second surface of the other board, and such that the angle of the slope of the second surface of the second finger relative to the second surface of the board is substantially equal to an angle of a slope of the second surface of the corresponding first finger of the other board relative to a first surface of the other board.

12. The method of claim 9, wherein the joints of the first and second boards each further comprise a plurality of alternating first and second fingers.

13. The method of claim 12, wherein, when the first board is joined to the second board, at least one side wall of each first finger of the first board contacts a corresponding side wall of a first finger of the second board, and at least one side wall of each second finger of the first board contacts a corresponding side wall of a second finger of the second board.

14. The method of claim 12, wherein each first finger has a length that is substantially equal to a length of each other first finger, and wherein each second finger has a length that is substantially equal to a length of each other second finger.

15. The method of claim 14, wherein the length of each first finger and the length of each second finger are substantially equal.

16. The method of claim 12, wherein the plurality of first and second fingers of the first board span an entire width of the first board, and wherein the plurality of first and second fingers of the second board span an entire width of the second board.

17. The method of claim 9, wherein the joints are formed by cutting, milling, casting, or molding.
